(19) United States
(12) Patent Application Publication
(10) Pub. No.: US 2017/0369254 A1
(43) Pub. Date: Dec. 28, 2017

(54) GROUPING DEVICE FOR ROWS OF PRODUCTS

(71) Applicant: Rotzinger AG, Kaiseraugst (CH)

(72) Inventor: Christian MULLER, Berrwiler (FR)

(73) Assignee: Rotzinger AG, Kaiseraugst (CH)

(21) Appl. No.: 15/538,671

(22) PCT Filed: Nov. 17, 2015
(86) PCT No.: PCT/EP2015/076778

§ 371 Date: Jun. 22, 2017

(30) Foreign Application Priority Data
Dec. 23, 2014 (CH) 02021/14

(51) Int. Cl. B65G 47/08; B65G 47/32; B65G 47/84; B65G 54/02

(52) U.S. Cl. CPC B65G 47/082; B65G 47/841; B65G 47/32; B65G 54/02

(57) ABSTRACT

The row-grouping device for moving rows of products relative to a stationary or moving base consists of two guide tracks of a linear transport system, said guide tracks circulating on both sides of the base and having individually driven drivers. In each case two successive drivers are connected to one another in pairs by a joint rod, and in each case two pairs of drivers positioned opposite from one another on the guide tracks are connected to one another mechanically in a transverse direction over the base.

The invention relates to a row-grouping device for moving rows of products relative to a stationary or moving base.

There are two known problems with the production of packaged goods in the foodstuffs industry, especially in the case of biscuits or other products that need to be transferred when arriving from an oven. Because the end of the process belt or the oven belt generally consists structurally of a very large end defection drum to which a subsequent conveyor belt, e.g., the main conveyor belt of a system, cannot be brought close to without a gap, the biscuits that are generally small must be transferred to the subsequent main conveyor belt by means of a transition plate. The products cannot be actively conveyed while they are located on the transition plate. This situation is frequently managed by arranging the transition plate obliquely in such a way that the products reach the subsequent belt in a sliding manner. Another variant consists of the subsequent row always shifting the row that is currently on the transition plate onto the subsequent main belt. In both variants, the existing order of the products within the rows and also the position of the rows relative to one another are disrupted. This systematic disorder in the row pattern produces serious disadvantages for the subsequent packaging process.

In addition, frequently the freshly produced rows of products must be transferred into another arrangement relative to one another and at another speed so that the requirements for the subsequent packaging process can be fulfilled. This is always accomplished subsequently with a number of specific belts and aligning devices.

The object of the invention is to solve the problem from the prior art in terms of the transfer of the rows of products and also to fulfill further requirements with respect to the arrangement and speed of the rows of products for the packaging process.

Said object is achieved according to the invention by a grouping device having the characterizing features of claim 1.

A preferred exemplary embodiment of the invention is described in the following based on the attached drawings, which show:

FIG. 1 A schematic sectional view of a grouping device for transferring products from a process belt P to a main conveyor belt V

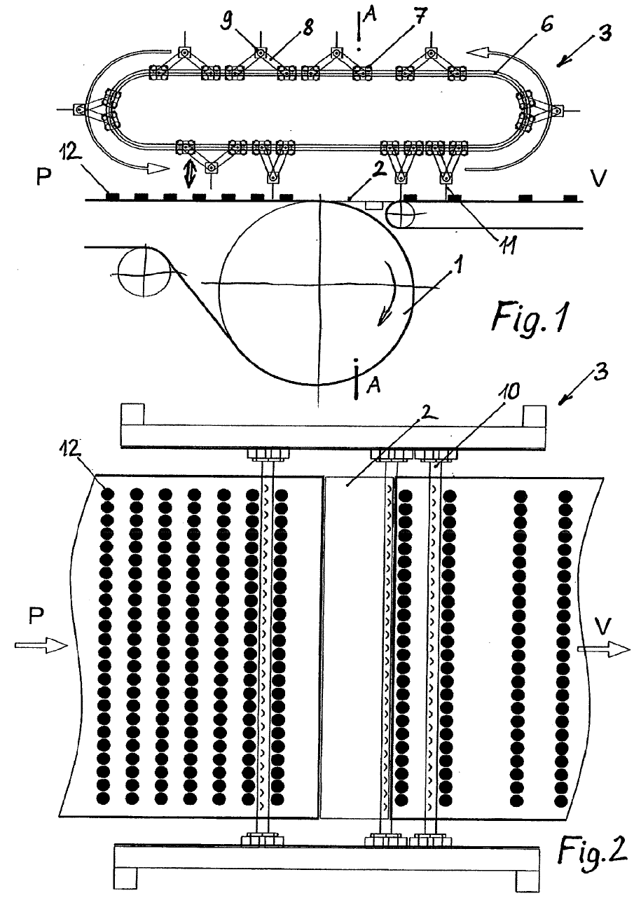

FIG. 2 A top view of the grouping device shown in FIG. 1

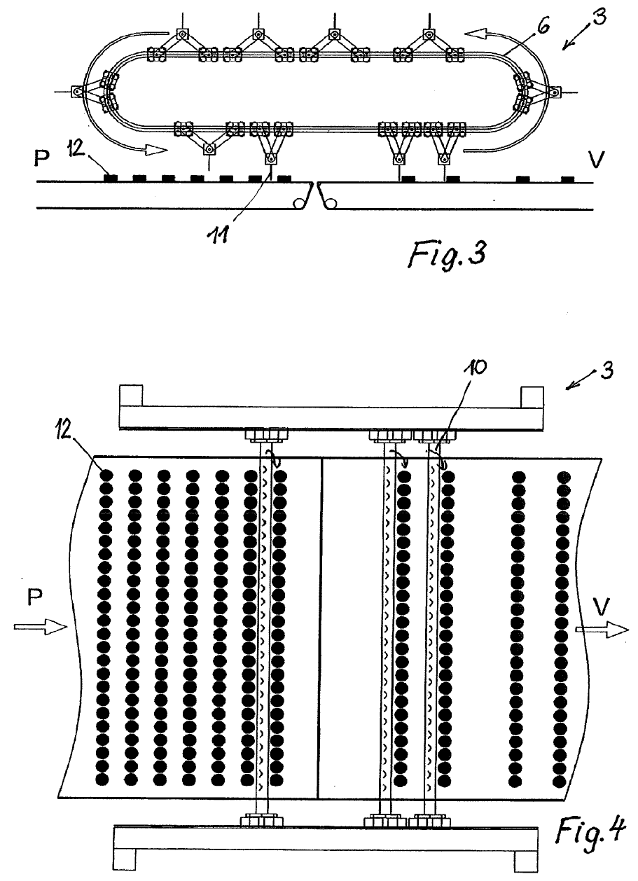

FIG. 3 A schematic sectional view of a grouping device for regrouping rows of products in the region of a normal transition from one belt to a subsequent one

FIG. 4 A top view of the grouping device shown in FIG. 4

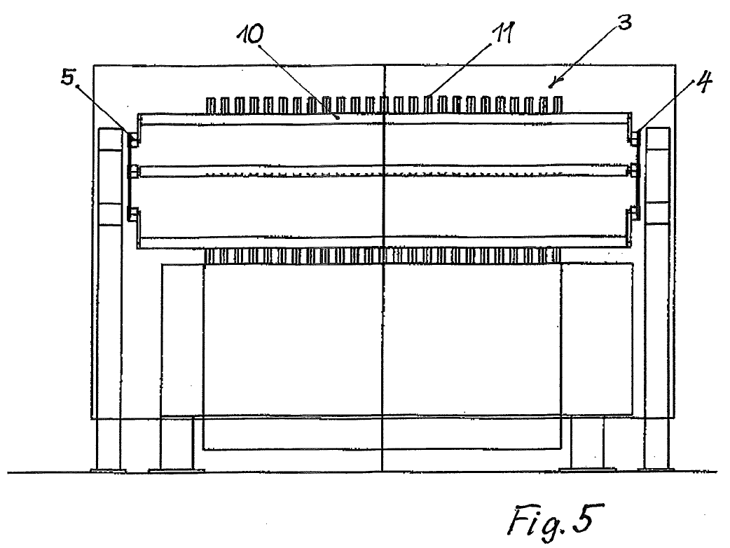

FIG. 5 A schematic sectional view along plane A-A in FIG. 1

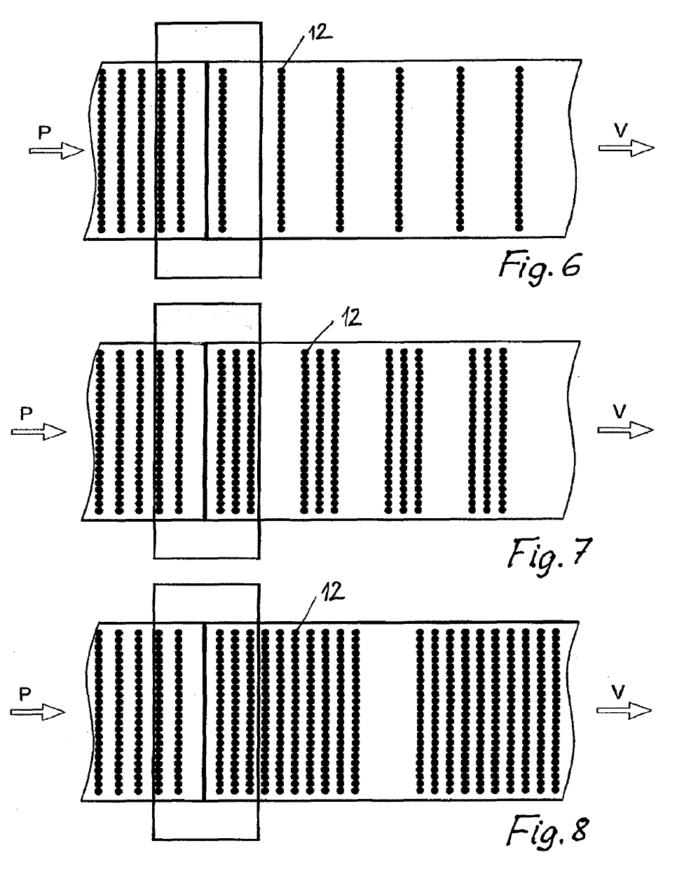

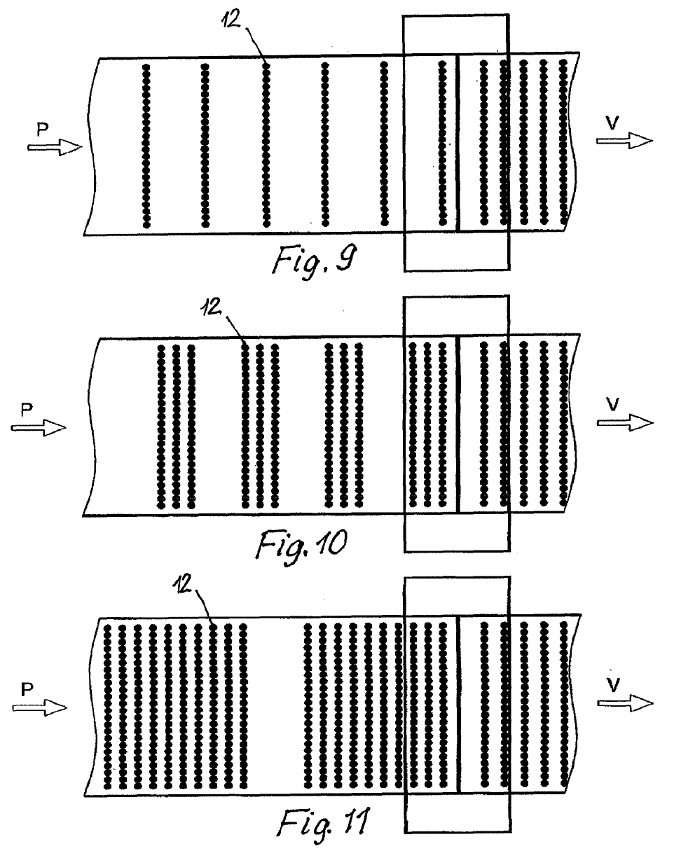

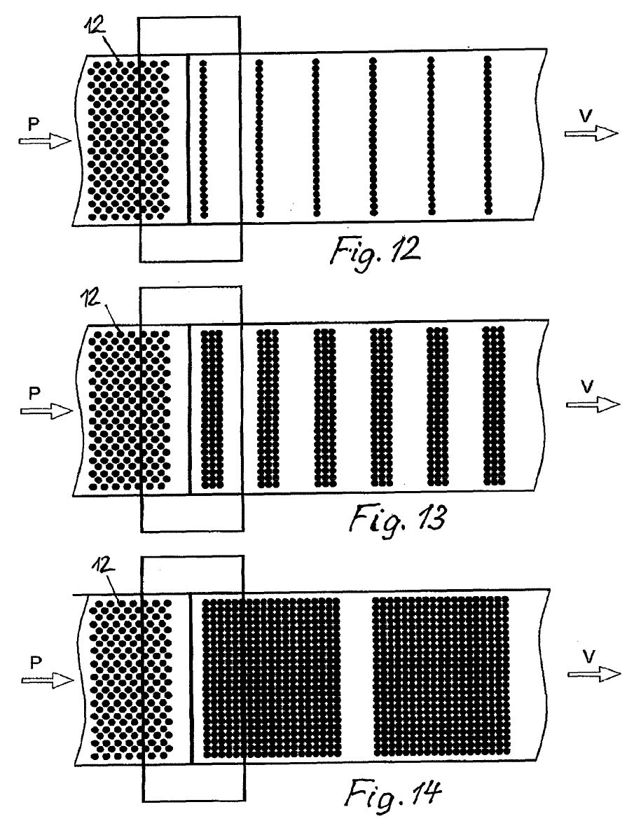

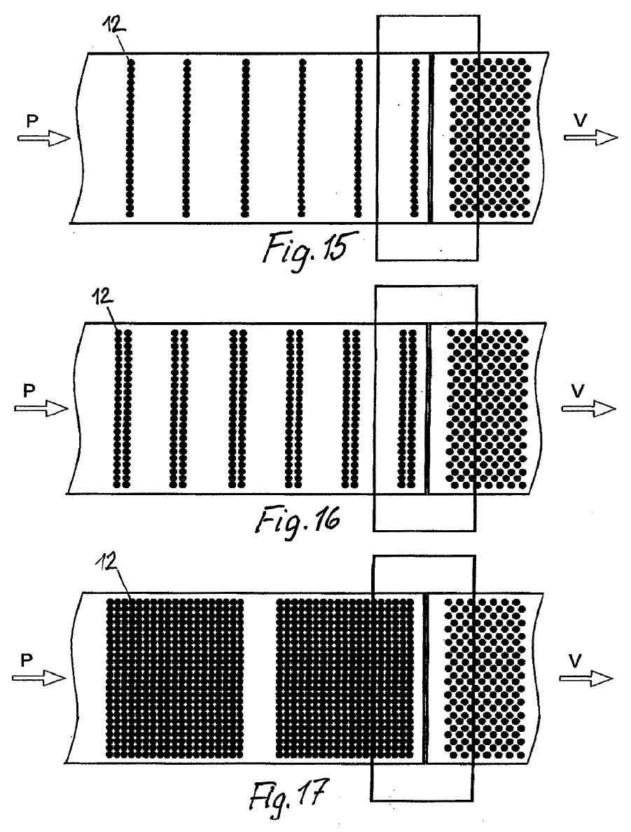

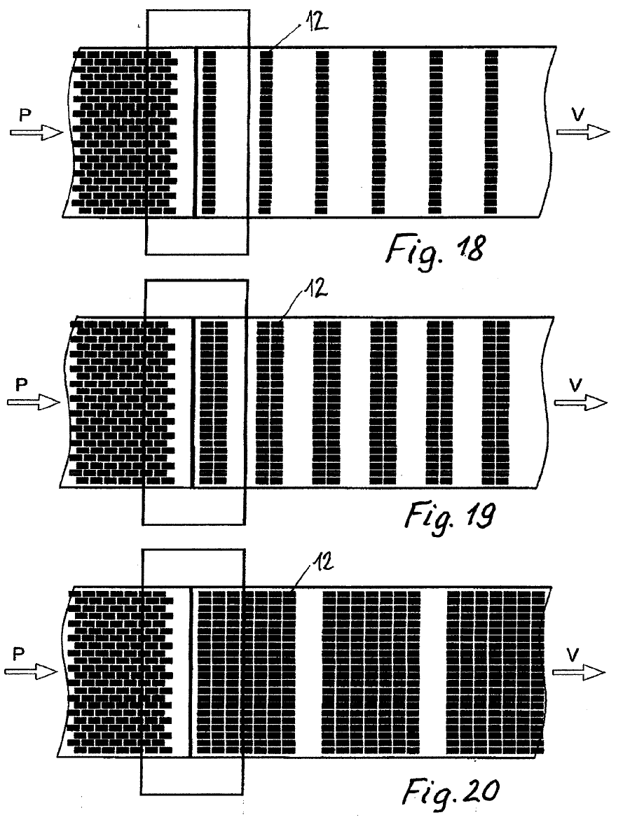

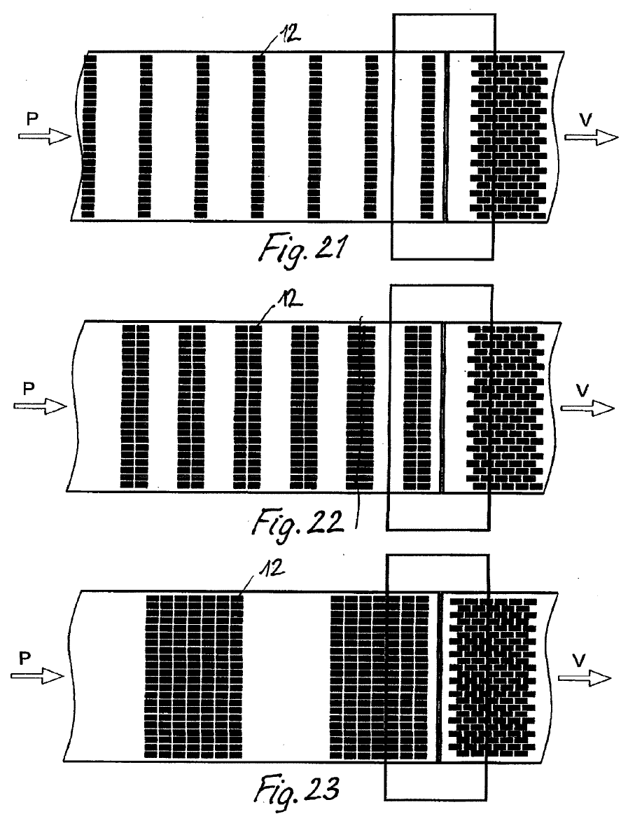

FIG. 6 to FIG. 23 Examples of different regrouping variations that are possible with the grouping device according to the invention

FIG. 24 A schematic sectional view of a grouping device for transferring products from a process belt P to a lower lying main conveyor belt V

As shown in FIG. 1, a process belt or oven belt P ends with an end defection drum 1 with a large diameter. A distance that exists between said process belt and a subsequent main conveyor belt V is bridged by a transition plate 2.

An active conveyance of the rows of products 12 takes place via a grouping device 3 arranged above the belts, which engages behind every row of products, conveys it actively via the transition plate and then releases it on the main conveyor belt.

As can be seen especially well in FIG. 5, the grouping device 3 consists of two linear transport systems 4 and 5, which are known per se and are arranged opposite from one another and parallel to one another on both sides of the conveyor tracks.

Such a linear transport system is offered in the market place under the designation of “XTS eXtended Transport System” by the company of Beckhoff, for example. This system has a number of circulating drivers 7, so-called movers, on a closed guide track 6, which are individually driven and controlled.

For the grouping device in accordance with the present invention, the control of the drivers is designed such that they move synchronously relative to one another on the guide tracks, i.e., there are always two associated drivers exactly opposite from one another.

In addition, in each case two successive drivers which are connected to one another by an isosceles joint rod 8 belong together on both of the two guide tracks. Depending on the distance of the two successive associated drivers, the middle joint 9 of the joint rod is height adjustable.

The opposing middle joints 9 of the two driver pairs on both guide rails are connected by a crosspiece 10. Attached on the underside of the crosspiece are aligning means 11, aligning cams in the design shown in FIG. 5. In another design variant, the aligning means consists of an aligning bar attached to the crosspiece and extending transversely over the belt. Because of the height adjustment mentioned, the crosspiece is also adjusted in terms of height with the aligning bar and specifically so that the aligning bar, in its deepest position, is able to dip into a gap between two rows of products. Because of the synchronous forward movement of the two driver pairs, the row of products is moved via the transition plate and transferred with a suitable speed to the subsequent belt.

In the situation depicted in FIGS. 3 and 4, the grouping device is arranged above a transfer location from a process belt P to a main belt V which is traveling more rapidly, and serves there to transfer the arriving rows of products to the main belt at a speed synchronous with said main belt.

In general, any desired flow with packaged goods can be transferred with a given row pattern via a belt transition and be modulated in the process to any desired flow with a differing row pattern.

A product flow of packaged goods arriving regularly in rows consisting of individual rows, double or multiple rows or formations with a uniform speed must be transferred from belt P to belt V. In the process, essentially the following requirements must be fulfilled:
1. The position-compliant transfer of the rows of products arriving on belt P and the position-compliant transfer of rows of products to the subsequent main belt V.
2. The speed-compliant synchronized transfer of the rows of products arriving on belt P and the speed-compliant synchronized transfer to the subsequent main belt.

There are also different arrangements of rows of packaged goods which arrive on the process belt. This is a result of the production process. A differentiation is basically made between two main arrangements. Firstly, this is a regular row pattern in which all rows have the same number of products and all products within the rows have the same relative position to one another. In this case, a continuous gap is present between adjacent rows transverse to the main conveyance direction.

Secondly, this is an offset row pattern in which e.g., alternatingly, the number of units of the products within the rows is different relative to one another and therefore the relative position of the products is also different from row to row. In this case, there is not typically a continuous gap between adjacent rows transverse to the main conveyance direction. Basically, the rows of products which arrive with a regular row pattern can be transferred with an aligning bar positioned transverse to the main conveyance direction via the belt transition. For this purpose, the aligning bar is synchronized with the speed of the process belt P and simultaneously positioned vertically downwards. As a result, the aligning bar then dips into the existing continuous gap between adjacent rows and can then move the row in question via the transition plate to the subsequent main belt P. In the process, it is possible in a superimposed manner to modulate every row individually in terms of speed so that any desired row pattern is able to be generated on the subsequent main belt.

Said transfer is also possible with an offset row pattern, which arrives on the process belt. In this case, there is no longer a continuous gap between adjacent rows. In the case of such an arrangement, the aligning bar is equipped with correspondingly suitable cams 10, which are then positioned transverse to the main conveyance direction vertically downward in the existing gaps between adjacent products in order to then also modulate or shift each row individually in terms of speed so that any desired row pattern is able to be generated on the subsequent main belt.

In addition to the transfer of rows of products or formations via a belt transition e.g., from an oven belt P with a very large deflection diameter to a downstream conveyor belt with a smaller deflection diameter, a plurality of different transfer variations is possible with the grouping device. Some of these transfer possibilities are shown in FIGS. 6-23.

Transfer of rows of products or formations arriving on belt P at an intermittent speed to belt V with a uniform speed. In other words, the flow of rows of products arriving with an intermittent speed is conveyed via the belt transition and transferred in a uniform continuous flow with a constant speed.

Transfer of rows of products or formations arriving on belt P at constant uniform speed to belt V with an intermittent speed. In other words, the flow of rows of products arriving with a constant speed is conveyed via the belt transition and transferred in an intermittent timed flow with a variable speed.

Transfer of a uniform product flow with a constant speed of arriving rows of packaged goods, which are offset from each other, in a uniform flow of rows, double or multiple rows or formations that are aligned relative to one another.

Transfer of a uniform product flow with an intermittent speed of arriving rows of packaged goods, which are offset from each other in a uniform flow of rows, double or multiple rows or formations that are aligned relative to one another.

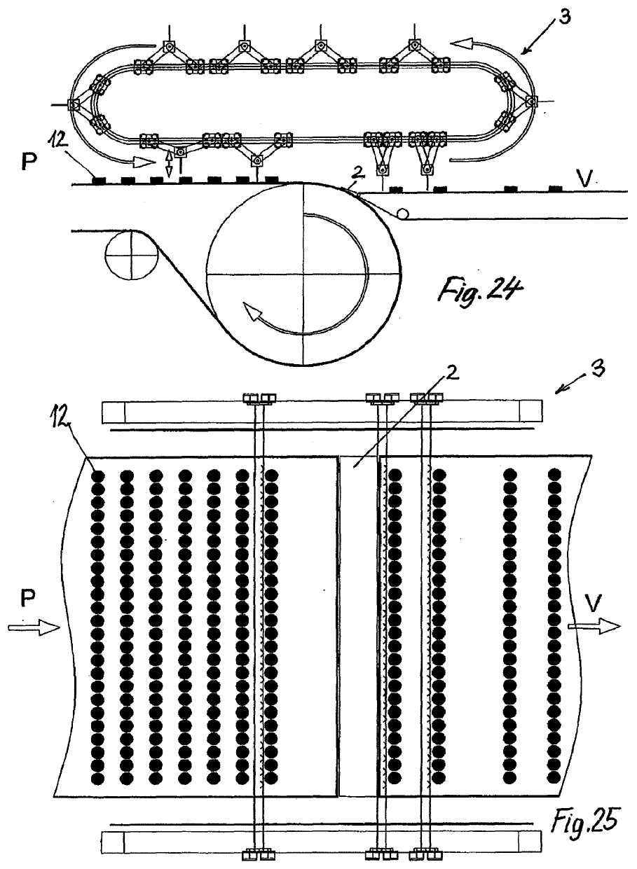

Transfer of a uniform product flow with an intermittent speed of arriving rows of packaged goods, which are offset from each other, in an intermittent flow of rows, double or multiple rows or formations that are aligned relative to one another.

Whereas in the case of the previously described exemplary embodiments, the two conveyor belts P and V are arranged at the same level, it is also possible with the device according to the invention, as depicted in FIGS. 24-25, to transfer rows of products from a process conveyor belt P to a main conveyor belt V, which is situated at another level than the process conveyor belt. The subsequent belt can thereby be lower or higher than the previous one. Of course, this also applies to the transition between the two belts shown in FIGS. 3-4.

1. Row-grouping device for moving rows of products relative to a stationary or moving base characterized in that a circulating guide track of a linear transport system having individually driven drivers is arranged on both sides of the base, that in each case two successive drivers are connected to one another in pairs by a joint rod and in each case two pairs of drivers positioned opposite from one another on the guide tracks are connected to one another mechanically in a transverse direction over the base.

2. Row-grouping device according to claim 1, characterized in that the drivers of a guide track that are mechanically coupled in pairs are connected to one another by a cross connection (crosspiece) to another guide track.

3. Row-grouping device according to claim 1, characterized in that the cross connection is height adjustable by means of the relative movement in relation to one another of the drivers that are individually coupled in pairs.

4. Row-grouping device according to claim 1, characterized in that the height adjustable cross connection is equipped with vertically arranged aligning means.

5. Row-grouping device according to claim 1, characterized in that the height adjustable cross connection is equipped with vertically arranged aligning cams.
